(19) United States
(12) Patent Application Publication
(10) Pub. No.: US 2026/0287121 A1
(43) Pub. Date: Sep. 24, 2026

(54) ENABLING HYDROGEN CONSUMPTION DURING REFILLING OF HYDROGEN

(71) Applicant: Volvo Truck Corporation, GÖTEBORG (SE)

(72) Inventors: Sigurd SONDEREGGER, Askim (SE); Pranav ARYA, Göteborg (SE)

(21) Appl. No.: 19/478,555

(22) PCT Filed: Apr. 27, 2023
(86) PCT No.: PCT/IB2023/054367

§ 371 Date: Oct. 24, 2025

(51) Int. Cl. F17C 13/02; B60S 5/02

(52) U.S. Cl. CPC F17C 13/026; B60S 5/02; F17C 13/025; F17C 2201/058; F17C 2221/012

(57) ABSTRACT

A method in a hydrogen delivery system having a plurality of hydrogen fuel tanks (HFTs) and at least one HFT (aHFT) of the HFTs configured to maintain hydrogen fuel to consumers (fuel cells and fuel consumers) during refueling of the HFTs, the method including: determining whether or not HFTs are set up for refueling; responsive to HFTs being set up: before the refueling process begins: initiating disconnection of HFTs to close while maintaining connection of the aHFT to the fuel consumers; providing pressure and temperature of a high pressure line providing fuel to HFTs to a fueling station interface or providing a maximum or average pressure and temperature of HFTs to the fueling station interface without providing a maximum or average pressure and temperature of the a HFT; and after the refueling process: initiating connection of the HFTs to the consumers to provide hydrogen fuel thereto.

### TECHNICAL FIELD

The disclosure relates generally to fuel cell systems. In particular embodiments, the disclosure relates to a fuel cell system having one or more hydrogen storage tanks used to avoid shutting down the fuel cell system during refueling.

The disclosure can be applied in heavy-duty vehicles, such as trucks, buses, and construction equipment. Although the invention will be described with respect to a particular vehicle, the invention is not restricted to any particular vehicle.

### BACKGROUND

As electric vehicle adoption continues to increase, efficient energy storage becomes increasingly valuable. For example, on fuel-cell electric vehicles (FCEVs), there is a need for storing energy in both batteries and onboard hydrogen fuel tanks. A fuel cell must be shut down during refueling of hydrogen as the fuel consumption of the fuel cell during a fill process translates into leakage, which sill stop the filling procedure. This is not acceptable from a fuel cell lifetime perspective as additional shutdowns will result in faster degradation of the fuel cell system and should be avoided. Additionally, this is also not acceptable from a customer perspective as fuel cell shutdown and start up are time consuming.

The Hydrogen fill station makes a leak tightness check on the vehicle by lifting the pressure on the vehicle side with a small amount of hydrogen, and then monitor the pressure. If the pressure is stable, the vehicle system is regarded leak tight, and the real filling process starts. The fuel consumption of the fuel cell or any other fuel consumer during the fill process will be translated into leakage, as the pressure is not stable, and this will stop the filling procedure.

### SUMMARY

According to a first aspect of the disclosure, a method in continuous hydrogen delivery system having a plurality of hydrogen fuel tanks with at least one hydrogen fuel tank of the plurality of hydrogen fuel tanks configured to maintain availability of hydrogen to one or more fuel consumers during refueling of the plurality of the hydrogen fuel tanks, the method performed by a controller and includes determining whether or not the plurality of hydrogen fuel tanks is set up for refueling. The method includes responsive to determining that the plurality of hydrogen fuel tanks is set up for refueling and before the refueling process begins, initiating disconnection of the plurality of hydrogen fuel tanks from the one or more fuel consumers while maintaining a connection of the at least one hydrogen fuel tank to at least one of the one or more fuel consumers. The method includes providing pressure and temperature of a high pressure line providing fuel to the plurality of hydrogen fuel tanks to a fueling station interface of a fueling station or providing a maximum or average pressure and temperature of the plurality of hydrogen fuel tanks to the fueling station interface without providing a maximum or average pressure and temperature of the at least one hydrogen fuel tank to the fueling station interface. The method includes, after the refueling process, initiating connection of the plurality of hydrogen fuel tanks to the one or more fuel consumers where the plurality of hydrogen fuel tanks including the at least one hydrogen fuel tank provides hydrogen fuel to the one or more fuel consumers. The first aspect of the disclosure may seek to keep hydrogen fuel flowing to the one or more fuel cells and the one or more fuel consumers during the refueling process. A technical benefit may include enabling the one or more fuel cells to continue operating during refueling instead of having to be turned off.

In some examples, providing the pressure and the temperature of the high pressure line or providing the maximum or average pressure and temperatures of the plurality of hydrogen fuel tanks includes commanding a combined check valve and solenoid valve, CSV, to close to prevent hydrogen fuel from the fuel station to flow to the at least one hydrogen fuel tank during a fuel station leak tightness check and commanding the CSV to open to provide hydrogen fuel from the fuel station to the at least one hydrogen fuel tank after the fuel station leak tightness check has been completed. A technical benefit may include enabling the fuel stating leak tightness check to be successful while continuing to provide fuel to the one or more fuel consumers.

In some examples, the method further includes transmitting a command to the one or more fuel consumers to minimize a hydrogen fuel draw during refueling of the plurality of hydrogen fuel tanks. A technical benefit may include reducing the amount of fuel draw during the refueling process.

In some examples, the method further includes determining whether or not at least one of the one or more fuel consumers remains operating during refueling. The method includes responsive to determining that the at least one of the one or more fuel consumer remains operating, commanding an inline solenoid valve to the one or more fuel consumers not operating to close while maintaining a connection of the at least one hydrogen fuel tank to the at least one of the one or more fuel consumers. A technical benefit may include preventing fuel from flowing between the plurality of hydrogen fuel tanks and the at least one of the one or more fuel consumers.

In some examples, the method further includes determining when the at least one of the one or more fuel consumer that remained operating has been shut down. The method further includes responsive to the at least one of the one or more fuel consumer has been shut down, commanding an inline solenoid valve to the at least one of the one or more fuel consumer to close while maintaining a connection of the at least one hydrogen fuel tank to any remaining fuel consumers of the at least one of the one or more fuel consumers. A technical benefit may include preventing fuel from flowing to the fuel consumer that was shut down.

In some examples, the method further includes determining whether or not all of the at least one of the one or more fuel consumers have been shut down. The method further includes responsive to determining that all of the at least one of the one or more fuel consumers have been shut down, commanding each inline solenoid valve connected to a fuel consumer of the one or more fuel consumers to close. A technical benefit may include preventing fuel from flowing to the fuel consumers.

In some examples, the method further includes determining a number of the at least one hydrogen fuel tank based on fuel consumption of the one or more fuel consumers that operate during the refueling process. A technical benefit may include providing a correct number of the at least one fuel tanks to fulfill the hydrogen fuel requirements.

According to additional embodiments, a continuous hydrogen delivery system includes a plurality of hydrogen fuel tanks configured to provide hydrogen fuel to a fuel cell and one or more fuel consumers. The continuous hydrogen delivery system includes at least one hydrogen fuel tank of the plurality of hydrogen fuel tanks configured to maintain availability of hydrogen fuel to the one or more fuel consumers during refueling of the plurality of hydrogen fuel tanks. The continuous hydrogen delivery system includes a first valve connected between the plurality of hydrogen fuel tanks and the at least one hydrogen fuel tank. The continuous hydrogen delivery system includes a second valve connected to the one or more fuel cells to control flow of hydrogen fuel to the one or more fuel cells. The continuous hydrogen delivery system includes at least one third valve connected to the one or more fuel consumers to control flow of hydrogen fuel to the one or more fuel consumers. The continuous hydrogen delivery system includes a controller configured to perform operations including determining whether or not the plurality of hydrogen fuel tanks is set up for refueling. The operations further include responsive to determining that the plurality of hydrogen fuel tanks is set up for refueling and before the refueling process begins, initiating disconnection of the plurality of hydrogen fuel tanks to close while maintaining a connection of the at least one hydrogen fuel tank to at least one of the one or more fuel consumers. The operations include providing pressure and temperature of a high pressure line providing fuel to the plurality of hydrogen fuel tanks to a fueling station interface of a fueling station or providing a maximum or average pressure and temperature of the plurality of hydrogen fuel tanks to the fueling station interface without providing a maximum or average pressure and temperature of the at least one hydrogen fuel tank to the fueling station interface. The operations include, after the refueling process, initiating reconnection of the plurality of hydrogen fuel tanks to the one or more fuel consumers where the plurality of hydrogen fuel tanks including the at least one hydrogen fuel tank provide hydrogen fuel to the one or more fuel consumers. The first aspect of the disclosure may seek to keep hydrogen fuel flowing to the one or more fuel cells and fuel consumer(s) during the refueling process. A technical benefit may include enabling the one or more fuel cells to continue operating during refueling instead of having to be turned off.

In some examples, in providing the pressure and the temperature of the high pressure line or providing the maximum or average pressure and temperatures of the plurality of hydrogen fuel tanks the controller operations include commanding a combined check valve and solenoid valve, CSV, to close to prevent hydrogen fuel from the fuel station to flow to the at least one hydrogen fuel tank during a fuel station leak tightness check and commanding the CSV to open to provide hydrogen fuel from the fuel station to the at least one hydrogen fuel tank after the fuel station leak tightness check has been completed. A technical benefit may include enabling the fuel stating leak tightness check to be successful while continuing to provide fuel to the one or more fuel cells and fuel consumer.

In some examples, the controller operations further include transmitting a command to the one or more fuel consumers to minimize a hydrogen fuel draw during refueling of the plurality of hydrogen fuel tanks. A technical benefit may include reducing the amount of fuel draw during the refueling process.

In some examples, the controller operations further include determining whether or not at least one of the one or more fuel consumers remains operating. The operations include responsive to determining that the at least one of the one or more fuel consumers remains operating, commanding an inline solenoid valve to the one or more fuel consumers to close while maintaining a connection of the at least one hydrogen fuel tank to the at least one of the one or more fuel consumers. A technical benefit may include preventing fuel from flowing between the plurality of hydrogen fuel tanks and the one or more fuel cells.

In some examples, the operations further include determining when the at least one of the one or more fuel consumer that remained operating has been shut down. The operations further include responsive to the at least one of the one or more fuel consumer has been shut down, commanding the inline solenoid valve to the at least one of the one or more fuel consumer to close while maintaining a connection of the secondary hydrogen fuel tank to any remaining fuel consumers of the at least one of the one or more fuel consumers that remain operating. A technical benefit may include preventing fuel from flowing to the fuel consumer that was shut down.

In some examples, the operations further include determining whether or not all of the at least one of the one or more fuel consumers have been shut down. The operations further include responsive to determining that all of the at least one of the one or more fuel consumers have been shut down, commanding each inline solenoid valve to the one or more fuel consumers to close. A technical benefit may include preventing fuel from flowing to the fuel consumers.

According to some other embodiments, a method in a continuous hydrogen delivery system having a plurality of hydrogen fuel tanks and at least one hydrogen tank of the plurality of hydrogen fuel tanks configured to maintain availability of hydrogen to at least one of one or more fuel consumers where the method is performed by a controller. The method includes determining that at least one of the one or more fuel consumers remains operating. The method includes responsive to the at least one of the one or more fuel consumer remains operating: commanding an inline solenoid valve to the one or more fuel cells to close while maintaining a connection of the at least one hydrogen fuel tank to the at least one of the one or more fuel consumers.

In some examples, the method further includes determining when the at least one of the one or more fuel consumer has been shut down. The method further includes responsive to the at least one of the one or more fuel consumer has been shut, commanding the inline solenoid valve to the at least one of the one or more fuel consumer to close while maintaining a connection of the at least one hydrogen fuel tank to any remaining fuel consumers of the at least one of the one or more fuel consumers that remain operating. A technical benefit may include preventing fuel from flowing to the fuel consumer that was shut down.

In some examples, the method further includes determining whether or not all of the at least one of the one or more fuel consumers have been shut down. The method further includes responsive to determining that all of the at least one of the one or more fuel consumers have been shut down, commanding each inline solenoid valve to the one or more fuel consumer to close. A technical benefit may include preventing fuel from flowing to the fuel consumers.

According to another aspect, a continuous hydrogen delivery system includes a plurality of hydrogen fuel tanks configured to provide hydrogen fuel to a fuel cell and one or more fuel consumers. The system includes at least one hydrogen tank of the plurality of hydrogen fuel tanks configured to provide hydrogen fuel to at least one of the one or more fuel consumers during refueling of the plurality of hydrogen fuel tanks. The system includes a controller configured to perform operations. The operations include determining that at least one of the one or more fuel consumers remains operating during refueling. The operations include responsive to the one or more fuel consumer remains operating: initiating disconnection of the plurality of hydrogen fuel tanks from the one or more fuel consumers while maintaining a connection of the at least one hydrogen fuel tank to the at least one of the one or more fuel consumers.

In some examples, the controller is further configured to perform further operations including determining when one of the at least one of the one or more fuel consumers that remained operating has been shut down. The method includes responsive to the at least one of the one or more fuel consumer has been shut down, commanding the inline solenoid valve to the one of the at least one of the one or more fuel consumer to close while maintaining a connection of the at least one hydrogen fuel tank to any remaining fuel consumers of the at least one of the one or more fuel consumers that remain operating. A technical benefit may include preventing fuel from flowing to the fuel consumer that was shut down.

In some examples, the controller is further configured to perform further operations including determining that all of the at least one of the one or more fuel consumers have been shut down. The method includes responsive to determining that all of the at least one of the one or more fuel consumers have been shut down, commanding each inline solenoid valve to the one or more fuel consumers to close. A technical benefit may include preventing fuel from flowing to the fuel consumer.

In some examples, at least one of the one or more fuel consumers is a hydrogen catalytic heater.

Additional features and advantages are disclosed in the following description, claims, and drawings, and in part will be readily apparent therefrom to those skilled in the art or recognized by practicing the embodiments as described herein.

### BRIEF DESCRIPTION OF THE DRAWINGS

With reference to the appended drawings, below follows a more detailed description of embodiments of the invention cited as examples.

FIG. 1 illustrates a conventional hydrogen delivery system where a plurality of hydrogen fuel tanks are providing hydrogen fuel to fuel cells;

FIG. 2 illustrates a hydrogen delivery system where at least one hydrogen fuel tank of the plurality of hydrogen fuel tanks is configured to provide hydrogen fuel to the one or more fuel consumers according to some embodiments;

FIG. 3 illustrates another embodiment of the hydrogen delivery system of FIG. 2 where the at least one hydrogen fuel tank provide hydrogen fuel during refueling of the plurality of hydrogen fuel tanks to the one or more fuel cells and/or a fuel consumer according to some embodiments;

FIG. 4 is a schematic diagram of a controller according to one example;

FIG. 5-7 are flow charts of operations of the controller of FIG. 4 to maintain availability of hydrogen to the one or more fuel consumers during refueling of the hydrogen fuel tanks according to one example;

FIG. 8 is a flowchart of operations of the controller of FIG. 4 to provide hydrogen fuel to one or more fuel consumers that remain operating during a time the refueling of the plurality of hydrogen tanks according to one example; and

FIG. 9 is a flow chart of a method to size the one or more secondary hydrogen fuel tanks according to one example.

### DETAILED DESCRIPTION

The embodiments set forth below represent the necessary information to enable those skilled in the art to practice the embodiments and illustrate the best mode of practicing the embodiments.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms.

These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

When a valve (e.g., inline solenoid valve, on-line tank valve, etc.) is open, the input and output of the valve are fluidly connected, and hydrogen fuel can flow through the valve. When a valve is closed, the input and output of the valve are not fluidly connected, and no hydrogen fuel flows through the valve.

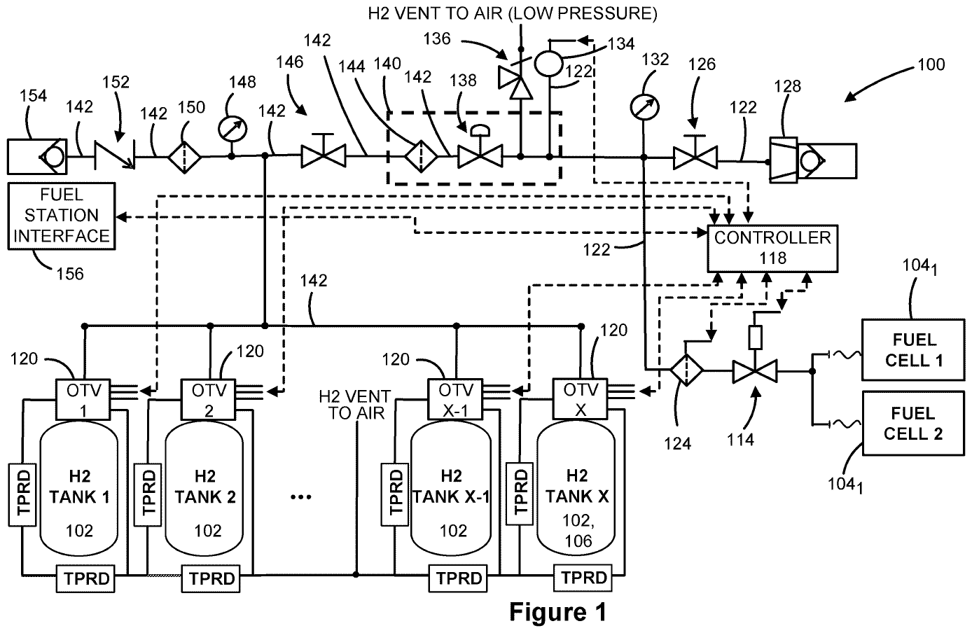

FIG. 1 illustrates a hydrogen delivery system 100 having a plurality of hydrogen fuel tanks 102 providing fuel to fuel cells 1041 of a vehicle and other fuel consumers 1042. At least one hydrogen tank 106 of the plurality of hydrogen fuel tanks 102 operates to provide hydrogen fuel to at least one fuel consumer 104 during refueling of the plurality of hydrogen fuel tanks 102.

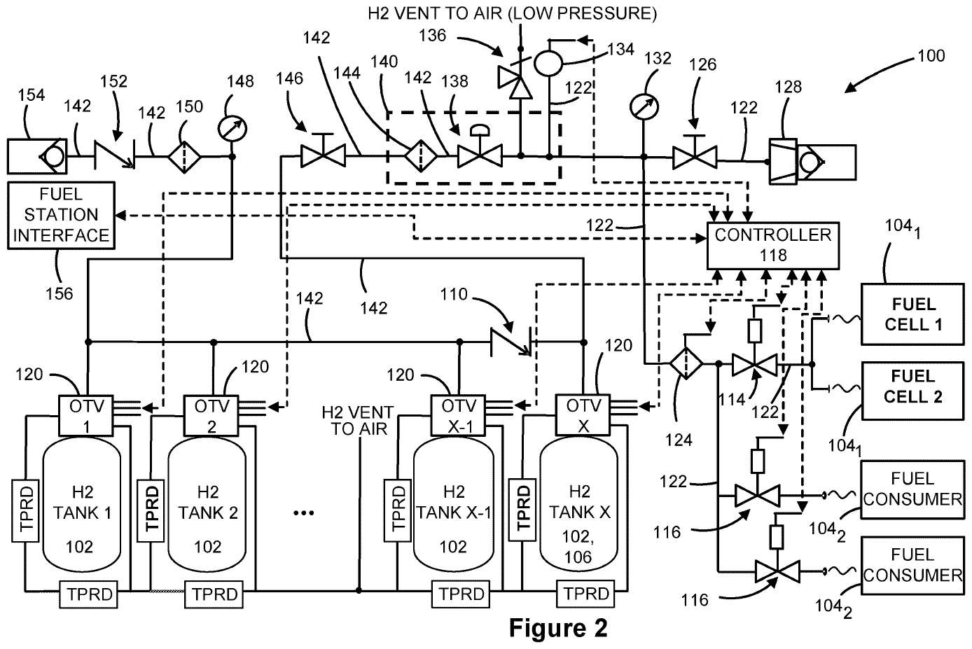

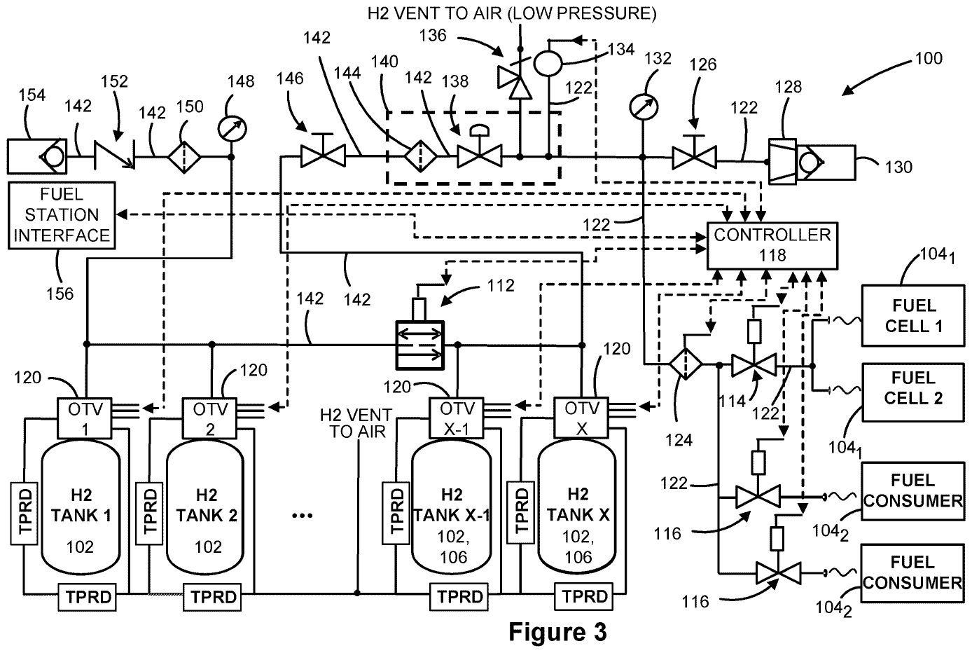

The plurality of hydrogen fuel tanks 102 collectively provide hydrogen fuel to the one or more fuel cells 1041 and fuel consumer 1042, collectively referred to as one or more fuel consumers 104. While only two fuel consumers is illustrated, there may be more than two fuel consumers 1042. A check valve 110 or a combined check valve and solenoid valve 112, collectively called CSV 110, 112 is between the plurality of hydrogen fuel tanks 102 and the at least one hydrogen fuel tank 106 as illustrated in FIGS. 2 and 3 according to embodiments of the present disclosure. When the CSV 110, 112 is operating as a check valve 110, the check valve 110 opens at a defined opening pressure. During normal operation, the CSV 110, 112 is open and the plurality of hydrogen fuel tanks 102 are connected to the at least one hydrogen fuel tank 106 and collectively provide hydrogen fuel to the fuel consumers 104.

The dashed lines in FIGS. 1-3 indicate control lines and signal lines where the various components communicate with the controller 118 to receive commands and provide signals such as pressure of a tank, temperature of a tank, valve status, etc. TPRD stands for temperature activated pressure relief device. The squiggly lines indicate a flexible hydrogen hose.

In these embodiments, an inline solenoid valve is connected to each fuel consumer. For example, inline solenoid valve 114 is connected to the one or more fuel cells 1041 and an inline solenoid valve 116 is connected to each of the fuel consumers 1042.

During operation, the controller 118 commands the on-tank valves 120 and the inline solenoid valves 114, 116 to be in an open position to provide hydrogen fuel to the one or more fuel consumers (i.e., fuel cells 1041 and fuel consumers 1042), respectively. Thus, when inline solenoid valve 114 is in the open position, hydrogen fuel is provided to the one or more fuel cells 1041. When the inline solenoid valve 114 is in the closed position, hydrogen fuel is not provided to the one or more fuel cells 1041. Similarly, when inline solenoid valve 116 is in the open position, hydrogen fuel is provided to the fuel consumer 1042 associated with the solenoid valve 116. When the inline solenoid valve 116 is in the closed position, hydrogen fuel is not provided to the fuel consumer 1042. When there are more than one fuel consumer 1042, only the fuel consumers that always need to be fueled together and are closed together are connected to the same inline solenoid valve 116 in one embodiment while other of the one or more fuel consumers 1042 are connected to separate inline solenoid valves 116. In another embodiment, each fuel consumer 1042 is connected to a separate inline solenoid valve 116 (i.e., for a number N of fuel consumers 1042, there are N inline solenoid valves 116).

The inline solenoid valves 114, 116 are connected to the low pressure hydrogen line 122 downstream of a coalescent filter 124. The additional components connected to the low pressure hydrogen line 122 include a manual shut off ball valve 126, an adapter block 128 for a service receptacle 130, a low pressure gauge 132, a low pressure transducer 134, a pressure relief valve 136, and an output of a pressure regulator 138 of a pressure regulator assembly 140.

The components connected to the high pressure line 142 include the plurality of hydrogen fuel tanks 102 via the on-line tank valves 120, the input of the pressure regulator 138, the CSV 110, 112, a filter 144 (e.g., a 10 micron filter), a manual shut off valve 146 (e.g., a ball valve), a high pressure gauge 148 an inline filter 150 (e.g., a 10 micron filter), a check valve 152 and a fill receptacle 154.

During operation, the hydrogen fuel from the plurality of hydrogen fuel tanks 102 including the at least one hydrogen fuel tank 106 is provided to the one or more fuel cells 1041 and, when the inline solenoid valve 116 is in the open position, to the fuel consumer 1042 connected to the solenoid valve 116. The coalescent filter block 120 can condition the hydrogen fuel pressure and flow.

When the plurality of hydrogen fuel tanks 102 need to be filled, the CSV 112 remains open and the inline solenoid valve 116 is opened in some embodiments. This allows the plurality of hydrogen fuel tanks 102 to be refueled while the fuel consumer 1042 is provided hydrogen fuel. In other embodiments, the controller 118 directs the one or more fuel cells 1041 to reduce hydrogen fuel draw during refueling and the inline solenoid valve 114 remains in the closed position during refueling.

Note that if the at least one hydrogen fuel tank 106 is too small, the CSV 110, 112 can be positioned upstream of additional hydrogen fuel tanks 102 as illustrated in FIG. 3.

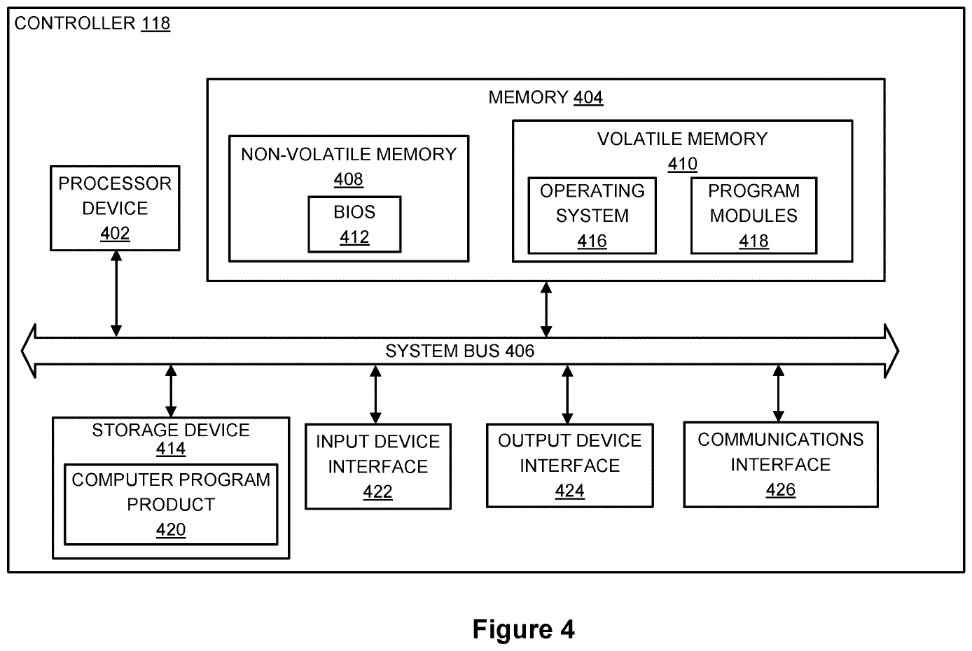

FIG. 4 is a schematic diagram of a controller 118 for implementing examples disclosed herein. The controller 118 is adapted to execute instructions from a computer-readable medium to perform these and/or any of the functions or processing described herein. The controller 118 may be connected (e.g., networked) to other machines in a LAN, an intranet, an extranet, or the Internet. While only a single device is illustrated, the controller 118 may include any collection of devices that individually or jointly execute a set (or multiple sets) of instructions to perform any one or more of the methodologies discussed herein.

The controller 118 may comprise any computing or electronic device capable of including firmware, hardware, and/or executing software instructions to implement the functionality described herein. The controller 118 includes a processor device 402 (may also be referred to as a control unit or processing circuitry), a memory 404, and a system bus 406. The system bus 406 provides an interface for system components including, but not limited to, the memory 404 and the processor device 402. The processor device 402 may include any number of hardware components for conducting data or signal processing or for executing computer code stored in memory 404. The processor device 402 (i.e., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the processor device 402 (e.g., via a circuit or any other wired, wireless, or network connection) and may include computer code for executing one or more processes described herein. The memory 404 may include non-volatile memory 308 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with a processor device 402. A basic input/output system (BIOS) 412 may be stored in the non-volatile memory 308 and can include the basic routines that help to transfer information between elements within the controller 118.

The controller 118 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

A number of modules can be stored in the storage device 414 and in the volatile memory 410, including an operating system 416 and one or more program modules 418, which may implement the functionality described herein in whole or in part. All or a portion of the examples disclosed herein may be implemented as a computer program product 420 stored on a transitory or non-transitory computer-usable or computer-readable storage medium (i.e., single medium or multiple media), such as the storage device 414, which includes complex programming instructions, such as complex computer-readable program code, to cause the processor device 402 to carry out the steps described herein. Thus, the computer-readable program code can comprise software instructions for implementing the functionality of the examples described herein when executed by the processor device 402. The processor device 402 may serve as a controller, or control system, for the controller 118 that is to implement the functionality described herein.

The controller 118 also may include an input device interface 422 (e.g., input device interface and/or output device interface). The input device interface 422 may be configured to receive input and selections to be communicated to the controller 118 when executing instructions, such as from a keyboard, mouse, touch-sensitive surface, etc. Such input devices may be connected to the processor device 402 through the input device interface 422 coupled to the system bus 406 but can be connected through other interfaces such as a parallel port, an Institute of Electrical and Electronic Engineers (IEEE) 1394 serial port, a Universal Serial Bus (USB) port, an IR interface, and the like. The controller 118 may include an output device interface 424 configured to forward output, such as to a display, a video display unit (e.g., a liquid crystal display (LCD) or a cathode ray tube (CRT)). The controller 118 may also include a communications interface 326 suitable for communicating with a network as appropriate or desired.

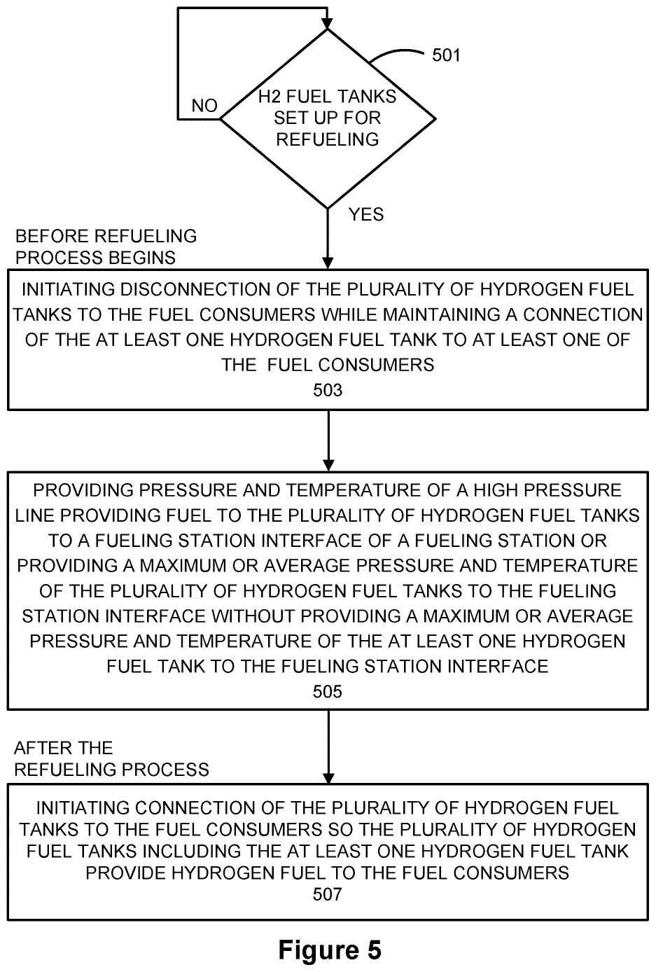

FIG. 5 illustrates operations the controller 118 performs in some embodiments such as the embodiments illustrated in FIGS. 2-3 during a refueling process. Turning to FIG. 5, in block 501, the controller 118 determines whether or not the plurality of hydrogen fuel tanks is set up for refueling. Responsive to determining that the plurality of hydrogen fuel tanks is set up for refueling and before the refueling process starts, the controller 118 in block 503 initiates disconnection of the plurality of hydrogen fuel tanks 102 to the one or more fuel consumers 104 while maintaining a connection of the at least one hydrogen fuel tank 106 to at least one of the one or more fuel consumers 104. In other words, all of the plurality of fuel tanks 102 except for the hydrogen fuel tank(s) 106 are disconnected for fueling the one or more fuel consumers 104.

In block 505, the controller 118 provides pressure and temperature of a high pressure line 142 providing fuel to the plurality of hydrogen fuel tanks 102 to a fueling station interface 156 of a fueling station or providing a maximum or average pressure and temperature of the plurality of hydrogen fuel tanks 102 to the fueling station interface 156 without providing a maximum or average pressure and temperature of the at least one hydrogen fuel tank 106 to the fueling station interface 156.

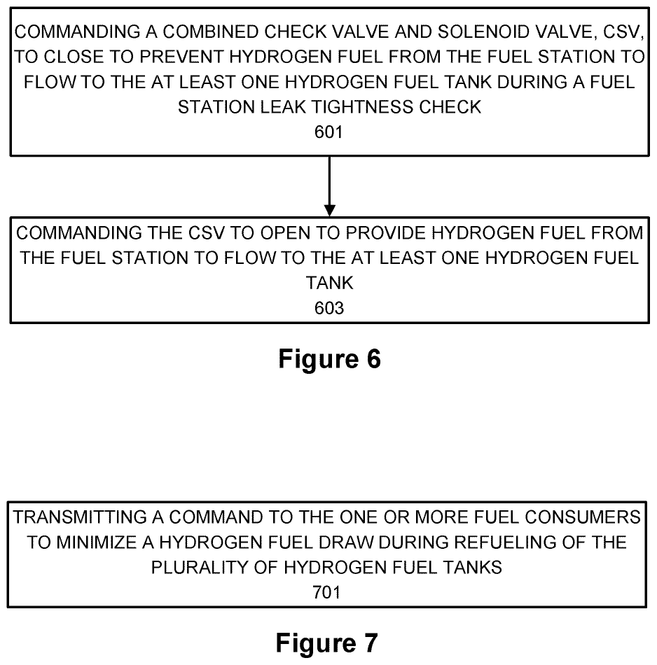

In one aspect, in providing the pressure and the temperature of the high pressure line 142 or providing the maximum or average pressure and temperatures of the plurality of hydrogen fuel tanks 102, the controller 118 commands the combined check valve and solenoid valve, CSV, 112 to close to prevent hydrogen fuel from the hydrogen fuel station to flow to the at least one hydrogen fuel tank 106 during a fuel station leak tightness check as illustrated in block 601 of FIG. 6. The controller 118 commands the CSV 112 to open to provide hydrogen fuel from the fuel station to the at least one hydrogen fuel tank 106 after the fuel station leak tightness check has been completed. This enables the fuel station leak tightness check to pass while maintaining hydrogen fuel flow to the one or more fuel cells 104 and/or the fuel consumers 108.

In some examples, to aid in reducing hydrogen fuel flow to the one or more fuel cells 104 and the one or more fuel consumers 108, the controller 118 transmits a command to the one or more fuel consumers to minimize a hydrogen fuel draw during refueling of the plurality of hydrogen fuel tanks 102 as illustrated by block 701 in FIG. 7.

In some examples, if a pressure difference between the plurality of hydrogen fuel tanks 103 and the one or more secondary hydrogen fuel tanks 106 gets above a defined threshold, then all OTVs 120 are opened for a period of time to equalize the pressure in all of the plurality of hydrogen tanks 102 and the one or more secondary hydrogen fuel tanks 106.

When the controller 118 determines that the plurality of hydrogen fuel tanks 102 has been refueled (and after the continuous hydrogen delivery system has been disconnected from the fuel station), the controller 118 in block 507 initiates connection of the plurality of hydrogen fuel tanks 102 to the one or more fuel consumers 104 so the plurality of hydrogen fuel tanks 102 including the at least one hydrogen fuel tank 106 provide hydrogen fuel to the one or more fuel consumers 104.

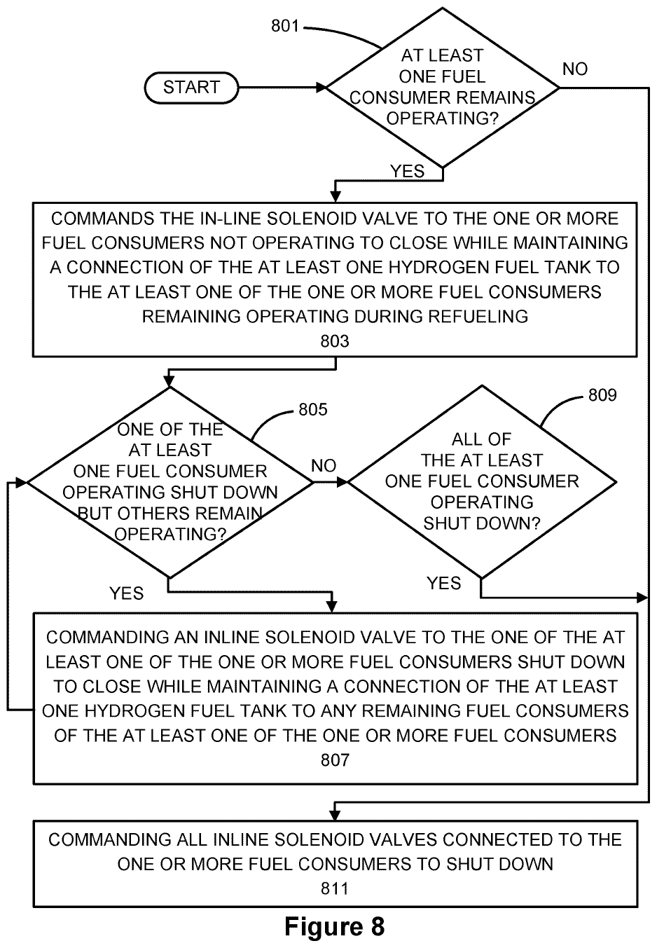

FIG. 8 illustrates another aspect of the continuous hydrogen delivery system 100 where the at least one hydrogen fuel tank 106 provide hydrogen fuel to at least one of the one or more fuel consumers 104. An example of such a scenario is running a cab heater using e.g., a hydrogen catalytic heater, when the one or more fuel cells 1041 are shut down. This allows a user of the vehicle in which the continuous hydrogen delivery system is installed to keep warm when in cold environments.

Turning to FIG. 8 in block 801, the controller 118 determines whether or not at least one of the one or more fuel consumers 104 remains operating during refueling. Responsive to the at least one of the one or more fuel consumers 104 remains operating, the controller 118 in block 803 commands an inline solenoid valve 114, 116 to the one or more fuel consumers 104 not operating to close while maintaining a connection of the at least one hydrogen fuel tank 106 to the at least one of the one or more fuel consumers 104.

In block 805, the controller 118 determines when one of the at least one of the one or more fuel consumers 104 has been shut down. In block 807, the controller 118 responsive to the one of the at least one of the one or more fuel consumers 104 has been shut down, commanding 807 the inline solenoid valve 116 to the one of the at least one of the one or more fuel consumer 104 to close while maintaining a connection of the at least one hydrogen fuel tank 106 to any remaining fuel consumers to the at least one of the one or more fuel consumers 104 that remain operating.

In block 809, the controller 118 determines whether or not all of the at least one of the one or more fuel consumers 104 have been shut down. In block 811, the controller 118, responsive to determining that all of the at least one of the one or more fuel consumers 104 have been shut down, commands each inline solenoid value 116 connected to a fuel consumer of the one or more fuel consumers 104 to close.

In some examples, the at least one of the one or more fuel consumers 104 is a hydrogen catalytic heater.

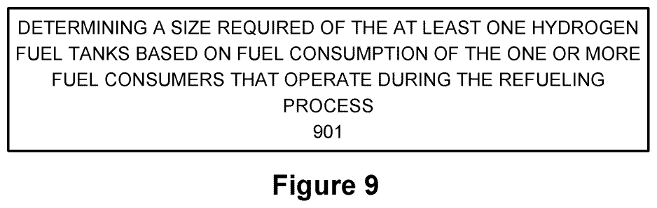

FIG. 9 illustrates sizing the at least one hydrogen fuel tank 106 based on fuel consumption. Turning to FIG. 9, in block 901, the controller 118 determines a number of the at least one hydrogen fuel tank 106 based on fuel consumption of the one or more fuel consumers 104 that operate during the refueling process.

The operational steps described in any of the exemplary embodiments herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

It is to be understood that the present invention is not limited to the embodiments described above and illustrated in the drawings; rather, the skilled person will recognize that many changes and modifications may be made within the scope of the present disclosure and appended claims.

1. A method in a hydrogen delivery system having a plurality of hydrogen fuel tanks with at least one hydrogen fuel tank of the plurality of hydrogen fuel tanks maintaining availability of hydrogen to one or more fuel consumers during refueling of the plurality of the hydrogen fuel tanks, the method performed by a controller and comprising:
determining whether or not the plurality of hydrogen fuel tanks is set up for refueling;
responsive to determining that the plurality of hydrogen fuel tanks is set up for refueling:
before a refueling process begins:
initiating disconnection of the plurality of hydrogen fuel tanks from the one or more fuel consumers while maintaining a connection of the one or more hydrogen fuel tanks to at least one of the one or more fuel consumers;
providing pressure and temperature of a high pressure line providing fuel to the plurality of hydrogen fuel tanks to a fueling station interface of a fueling station or providing a maximum or average pressure and temperature of the plurality of hydrogen fuel tanks to the fueling station interface without providing a maximum or average pressure and temperature of the at least one hydrogen fuel tank to the fueling station interface and
after the refueling process:
initiating connection of the plurality of hydrogen fuel tanks to the one or more fuel consumers where the plurality of hydrogen fuel tanks including the one or more hydrogen fuel tanks provide hydrogen fuel to the one or more fuel consumers.

2. The method of claim 1 wherein providing the pressure and the temperature of the high pressure line or providing the maximum or average pressure and temperatures of the plurality of hydrogen fuel tanks comprises:
commanding a combined check valve and solenoid valve, CSV, to close to prevent hydrogen fuel from the fuel station to flow to the at least one hydrogen fuel tank during a fuel station leak tightness check; and
commanding the CSV to open to provide hydrogen fuel from the fuel station to the at least one hydrogen fuel tank after the fuel station leak tightness check has been completed.

3. The method of claim 1, further comprising transmitting a command to the one or more fuel consumers to minimize a hydrogen fuel draw during refueling of the plurality of hydrogen fuel tanks.

4. The method of claim 1, further comprising:
determining whether or not at least one of the one or more fuel consumers remains operating during refueling:
responsive to determining that the at least one of the one or more fuel consumer remains operating:
commanding an inline solenoid valve to the one or more fuel consumers not operating to close while maintaining a connection of the at least one hydrogen fuel tank to the at least one of the one or more fuel consumers remaining operating during refueling of the plurality of hydrogen fuel tanks.

5. The method of claim 4, further comprising:
determining when one of the at least one of the one or more fuel consumer that remained operating has been shut down while others of the at least one of the one or more fuel consumers remains operating;
responsive to the at least one of the one or more fuel consumer has been shut down, commanding an inline solenoid valve to the at least one of the one or more fuel consumer to close while maintaining a connection of the at least one hydrogen fuel tank to any remaining fuel consumers of the at least one of the one or more fuel consumers that remain operating.

6. The method of claim 5, further comprising:
determining whether or not all of the at least one of the one or more fuel consumers have been shut down; and
responsive to determining that all of the at least one of the one or more fuel consumers have been shut down, commanding each inline solenoid valve connected to a fuel consumer of the one or more fuel consumers to close.

7. The method of claim 1, further comprising:
determining a number of the at least one hydrogen fuel tanks based on fuel consumption of the one or more fuel consumers that operate during the refueling process.

8. A continuous hydrogen delivery system comprising:
a plurality of hydrogen fuel tanks configured to provide hydrogen fuel to one or more fuel cells and one or more fuel consumers;
at least one hydrogen fuel tank of the plurality of hydrogen fuel tanks configured to maintain availability of hydrogen fuel to the one or more fuel consumers during refueling of the plurality of hydrogen fuel tanks;
a first valve connected between the plurality of hydrogen fuel tanks and the at least one hydrogen fuel tank;
a second valve connected to the one or more fuel cells to control flow of hydrogen fuel to the one or more fuel cells;
at least one third valve connected to the one or more fuel consumers to control flow of hydrogen fuel to the one or more fuel consumers; and
a controller configured to perform operations comprising:
determining whether or not the plurality of hydrogen fuel tanks is set up for refueling;
responsive to determining that the plurality of hydrogen fuel tanks is set up for refueling:
before a refueling process begins:
initiating disconnection of the plurality of hydrogen fuel tanks from the one or more fuel consumers while maintaining a connection of the at least one hydrogen fuel tank to at least one of the one or more fuel consumers
providing pressure and temperature of a high pressure line providing fuel to the plurality of hydrogen fuel tanks to a fueling station interface of a fueling station or providing a maximum or average pressure and temperature of the plurality of hydrogen fuel tanks to the fueling station interface without providing a maximum or average pressure and temperature of the at least one hydrogen fuel tank to the fueling station interface; and
after the refueling process:
initiating connection of the plurality of hydrogen fuel tanks to the one or more fuel consumers where the plurality of hydrogen fuel tanks including the at least one hydrogen fuel tank provide hydrogen fuel to the one or more fuel consumers.

9. The continuous hydrogen delivery system of claim 8 wherein in providing the pressure and the temperature of the high pressure line or providing the maximum or average pressure and temperatures of the plurality of hydrogen fuel tanks, the controller is further configured to perform operations comprising:
commanding a combined check valve and solenoid valve, CSV, to close to prevent hydrogen fuel from the fuel station to flow to the at least one hydrogen fuel tank during a fuel station leak tightness check; and
commanding the CSV to open to provide hydrogen fuel from the fuel station to the at least one hydrogen fuel tank.

10. The continuous hydrogen delivery system of claim 8, wherein the controller is further configured to perform operations comprising transmitting a command to the one or more fuel consumers to minimize a hydrogen fuel draw during refueling of the plurality of hydrogen fuel tanks.

11. The continuous hydrogen delivery system of claim 8, wherein the controller is further configured to perform operations comprising:
determining whether or not at least one of the one or more fuel consumers remains operating during refueling:
responsive to determining that the at least one of the one or more fuel consumers remains operating:
commanding an inline solenoid valve to the one or more fuel consumers not operating to close while maintaining a connection of the at least one hydrogen fuel tank to the at least one of the one or more fuel consumers.

12. The continuous hydrogen delivery system of claim 11, wherein the controller is further configured to perform operations comprising:
determining when the at least one of the one or more fuel consumer that remained operating has been shut down;
responsive to the at least one of the one or more fuel consumer has been shut down, commanding an inline solenoid valve to the at least one of the one or more fuel consumer to close while maintaining a connection of the at least one hydrogen fuel tank to any remaining fuel consumers of the at least one of the one or more fuel consumers that remain operating.

13. The continuous hydrogen delivery system of claim 12, wherein the controller is further configured to perform operations comprising:
determining whether or not all of the at least one of the one or more fuel consumers have been shut down; and
responsive to determining that all of the at least one of the one or more fuel consumers have been shut down, commanding each inline solenoid valve to the one or more fuel consumers to close.

14. A method in a continuous hydrogen delivery system having a plurality of hydrogen fuel tanks and at least one hydrogen fuel tank of the plurality of hydrogen fuel tanks configured to maintain availability of hydrogen to at least one of one or more fuel consumers during refueling of the hydrogen fuel tanks the method performed by a controller and comprising:
determining that the at least one of the one or more fuel consumers remains operating during the refueling;
responsive to the at least one of the one or more fuel consumer remains operating:
commanding an inline solenoid valve to the one or more fuel consumers to close while maintaining a connection of the at least one hydrogen fuel tank to the at least one of the one or more fuel consumers.

15. The method of claim 14, further comprising:
determining when the at least one of the one or more fuel consumer that remained operating has been shut down;
responsive to the at least one of the one or more fuel consumer has been shut down and the one or more fuel cells remains shut down, commanding an inline solenoid valve to the at least one of the one or more fuel consumer to close while maintaining a connection of the at least one hydrogen fuel tank to any remaining fuel consumers of the at least one of the one or more fuel consumers.

16. The method of claim 15, further comprising:
determining whether or not all of the at least one of the one or more fuel consumers have been shut down; and
responsive to determining that all of the at least one of the one or more fuel consumers have been shut down, commanding each inline solenoid valve to the one or more fuel consumers to close.

17. A continuous hydrogen delivery system comprising:
a plurality of hydrogen fuel tanks configured to provide hydrogen fuel to one or more fuel cells and one or more fuel consumers;
at least one hydrogen fuel tank the plurality of hydrogen fuel tanks to configured to provide hydrogen fuel to at least one of the one or more fuel consumers when the one or more fuel cells is shut down;
a controller configured to perform the method of claim 14.

18. The continuous hydrogen delivery system of claim 17, wherein the controller is further configured to perform further operations comprising:
determining when one of the at least one of the one or more fuel consumers that remained operating has been shut down;
responsive to the at least one of the one or more fuel consumer has been shut down, commanding an inline solenoid valve to the one of the at least one of the one or more fuel consumer to close while maintaining a connection of the at least one hydrogen fuel tank to any remaining fuel consumers of the at least one of the one or more fuel consumers.

19. The continuous hydrogen delivery system of claim 18, wherein the controller is further configured to perform further operations:
determining that all of the at least one of the one or more fuel consumers have been shut down; and
responsive to determining that all of the at least one of the one or more fuel consumers have been shut down, commanding each inline solenoid valve to the one or more fuel consumers to close.

20. The continuous hydrogen delivery system of Claim 17, wherein the at least one of the one or more fuel consumers comprises a hydrogen catalytic heater.
